(19) United States
(12) Patent Application Publication
(10) Pub. No.: US 2007/0073859 A1
(43) Pub. Date: Mar. 29, 2007

(54) Peer name resolution and discovery

(75) Inventors: Ravi T. Rao, Redmond, WA (US); Tomer Weisberg, Bellevue, WA (US); Sandeep Kishan Singhal, Kirkland, WA (US); Christian Huitema, Clyde Hill, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/238,194

(22) Filed: Sep. 29, 2005

(51) Int. Cl. G06F 15/173

(52) U.S. Cl. 709/223

(57) ABSTRACT

By adding a server as a node on a peer-to-peer network, the network may become more scalable, more reliable and more manageable, especially when the peer-to-peer network becomes very large.

### BACKGROUND

Peer-to-peer networking allows peers to communicate directly with each other without having to communicate through a central server. As such, many of the services provided by a central server are distributed to the nodes on the peer-to-peer network. This distribution of services has the advantage of ensuring that there is no single point of failure. At the same time, the authentication, categorization and rapid name discovery and resolution services commonly provided by a server may be lost.

### SUMMARY

By adding a server as a node on a peer-to-peer network, the network may become more scalable, more reliable and more manageable, especially when the peer-to-peer network becomes very large. The server may be a node on the network and may receive and store registration data in a memory. The server may also keep the registration data current in a manner that would not be taxing on the network, may authenticate users to ensure malicious nodes do not cause problems and may allow authenticated nodes to communicate with other authenticated nodes as well as forbid non-authenticated nodes from communicating with authenticated nodes. The server may also categorize the users of the peer-to-peer network, making searches for similar users more efficient.

### DRAWINGS

FIG. 1 is a block diagram of a computing system that may operate in accordance with the claims;

FIG. 2 is an illustration of a sample peer-to-peer network;

FIG. 3 is a flowchart of a method of peer name discovery (and resolution) in a peer-to-peer network;

FIG. 4 is a flowchart of adjusting the method of node registration data querying in accordance with the claims;

FIG. 5 is a flowchart of adjusting the method of node registration data querying in accordance with the claims;

FIG. 6 is a flowchart of analysis and categorization of node registration data in accordance with the claims; and

FIG. 7 is a flowchart of authentication of node registration data in accordance with the claims.

### DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘_’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

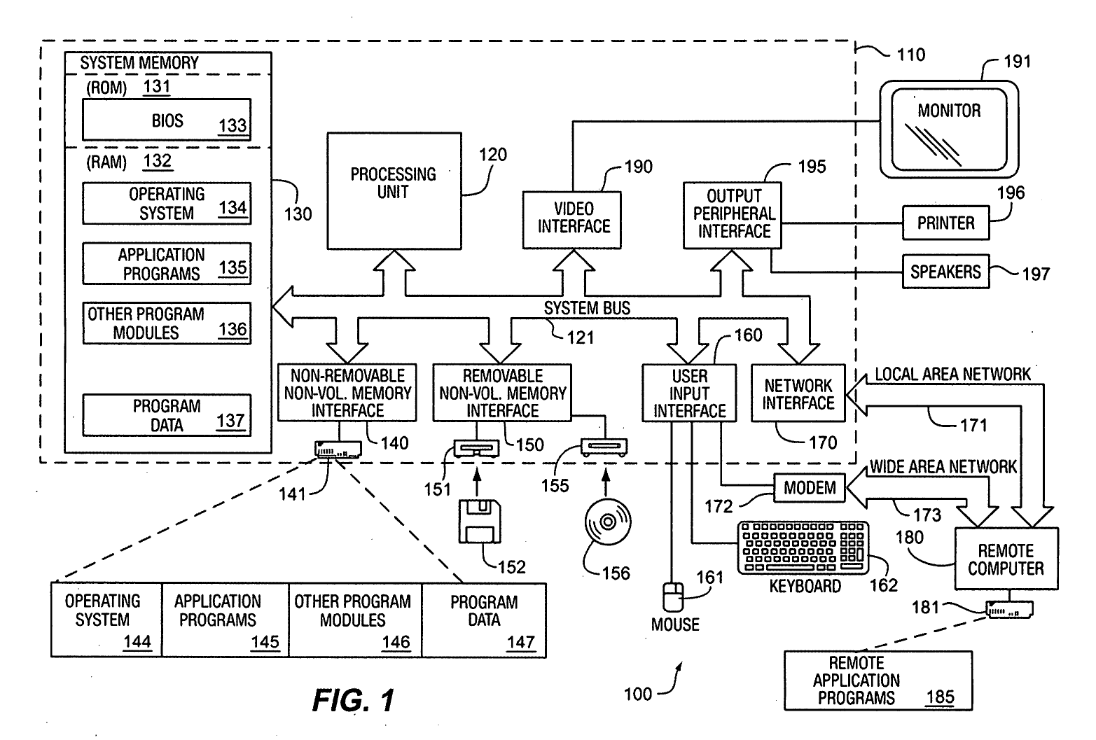

FIG. 1 illustrates an example of a suitable computing system environment 100 on which a system for the steps of the claimed method and apparatus may be implemented. The computing system environment 100 is only one example of a suitable computing environment and is not intended to suggest any limitation as to the scope of use or functionality of the method of apparatus of the claims. Neither should the computing environment 100 be interpreted as having any dependency or requirement relating to any one or combination of components illustrated in the exemplary operating environment 100.

The steps of the claimed method and apparatus are operational with numerous other general purpose or special purpose computing system environments or configurations. Examples of well known computing systems, environments, and/or configurations that may be suitable for use with the methods or apparatus of the claims include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The steps of the claimed method and apparatus may be described in the general context of computer-executable instructions, such as program modules, being executed by a computer. Generally, program modules include routines, programs, objects, components, data structures, etc. that perform particular tasks or implement particular abstract data types. The methods and apparatus may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the steps of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

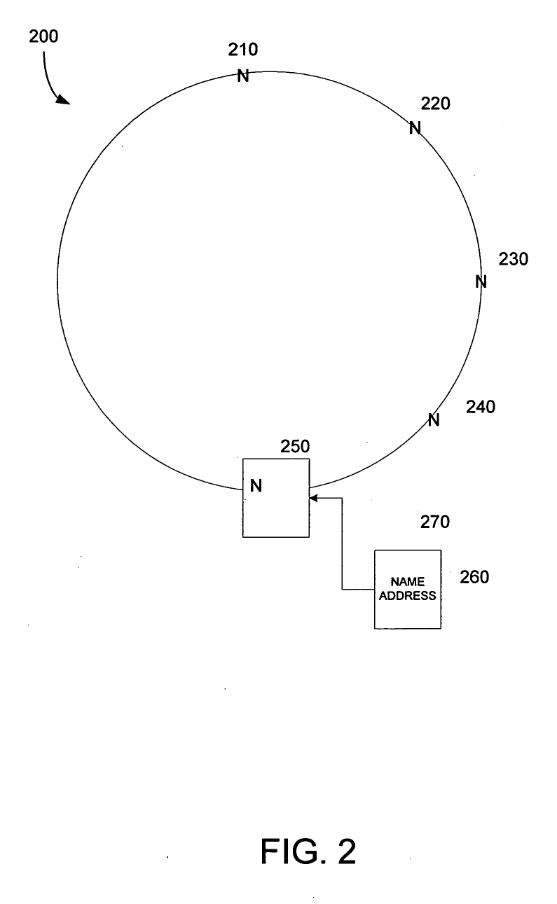

FIG. 2 is an illustration of a peer-to-peer network 200. In a peer-to-peer network 200, a node 210 may communicate or connect to other nodes 220, 230, 240 unlike a traditional network where the nodes connect to a central server and communicate with each other through the central server. In a peer-to-peer network 200, there is no reason that one of the nodes could not be a server such as server 250.

In a peer-to-peer network 200, usually each node has to create, store and update a list of all or a subset of other nodes that are part of the network. This list may contain a name (or an encoding of a name, a numeric identifier, or some other unique representation for the node) for each node and an address which may be used to reach the node. Names and addresses can be obtained by a node broadcasting its name and address or by a node inquiring of other nodes on the network for name and address information. The process to obtain and maintain a list of peer names can take up bandwidth on the peer-to-peer network 200, particularly because the active nodes and their addresses are dynamic. Further, when each node only maintains a list of a subset of other nodes, requests to find another node may have to rotate through a significant number of nodes until the desired node is located.

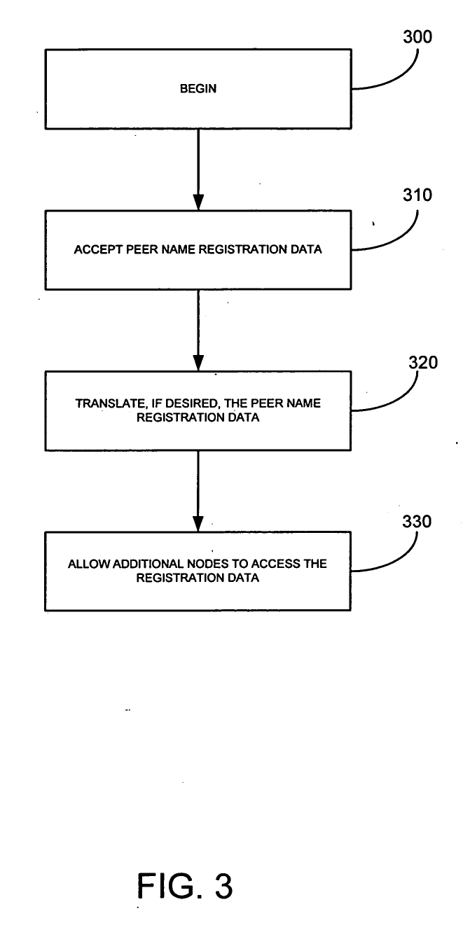

FIG. 3 depicts a method of peer name discovery. The method may also be used for peer name resolution. At block 300, a computer implemented method of peer name discovery (and resolution) in a peer-to-peer network 200 may begin. At block 310, a node (such as node 250 from FIG. 2) in a peer-to-peer network 200 may accept peer name registration data 260 (FIG. 2) from a node (such as nodes 210, 220, 230, 240 from FIG. 2) using a particular protocol. A single node may have a variety of peer names. For example, the Brady family may have a single network connection and but may have multiple peer names, such as Greg Brady, Marsha Brady, Peter Brady, etc. In addition, the Brady family may have multiple computers and each computer may have its own network address. At block 310, a node in a peer-to-peer network 200 may accept peer name registration data 260 from Greg Brady, Marsha Brady, Peter Brady, etc.

At block 320, a method is established to translate the peer name registration data and/or protocol 260 to a first format. For example, some people on the peer-to-peer network 200 may use the DNS host name format to identify other nodes in the peer-to-peer network and use the DNS protocol to query for addresses corresponding to DNS host names; others with more modern systems may use Peer Name Resolution Protocol (“PNRP”) name format and protocol to respectively identify hosts and retrieve their addresses. In a first embodiment, the method may be established through the designation of a well-known server (for example, a DNS server with responsibility for a well-known domain name). In a second embodiment, the method may be established through translation services provided by an arbitrary collection of hosts (for example, by all hosts participating in the PNRP protocol). It should be noted that the translation provided by the established method may not actually require an actual change in protocol or format; for example, the translation might map data received from one authoritative domain into data transmitted to a second authoritative domain without specifically changing the protocol or format of that data.

At block 330, the method may allow nodes using name registration data and/or protocols in the first format to access the registration data and/or protocol 260. For example (and in illustration of the aforementioned second embodiment), Greg Brady may work on the computer in the attic and may be on the peer-to-peer network 200 (FIG. 2). As a result, the memory in his computer may have collected a useful amount of peer names and addresses and be able to issue queries to obtain additional names and addresses. Marsha Brady may log into the peer-to-peer network 200 from her bedroom, but she may be incapable of accessing peer names and addresses because her computer does not support the latest protocols. Marsha's computer may query Greg's computer and may be able to access the significant peer name and address information that may be stored in Greg's memory or that may be accessible from Greg's computer.

As an illustration of the aforementioned first embodiment, a server (such as server 250 from FIG. 2) may take the role of Greg's computer. The server 250 may be part of the peer network 200 and the server may be capable of obtaining, updating and providing registration data 260 such as network peer name and address data to nodes that join the peer-to-peer network 200. The addition of a server to a peer-to-peer network 200 may have some benefits such as providing some authentication enforcement and may provide for more predictable performance of the peer-to-peer network 200.

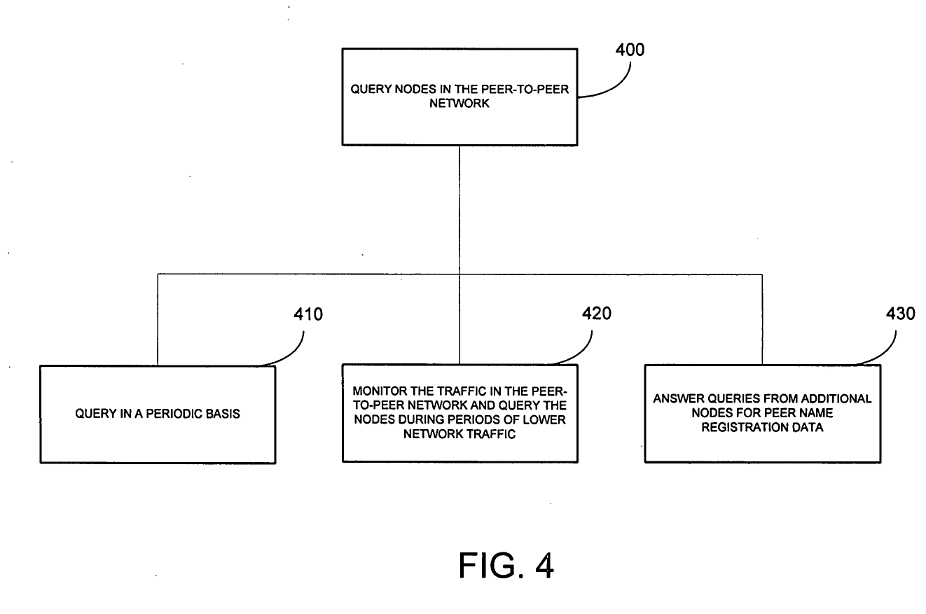

One of the possible differences of having a server as part of the peer-to-peer 200 network may be that obtaining registration data 260 may be better controlled. Instead of having multiple nodes requesting and announcing registration data 260, a single node may take on this role. FIG. 4 may illustrate some additional blocks that may provide benefits of having a server be part of a peer-to-peer network 200.

At block 400, the node, which may be a server node, may query nodes in the peer-to-peer network 200 for registration data 260. The query may be dependent of the format of the peer-to-peer network. Methods of querying or obtaining addresses are well known and do not affect the invention herein described.

At block 410, the querying may be performed in a periodic basis. For example, the node may determine to query for addresses every thirty seconds. By periodically querying, network performance may be more predictable (because the queries are issued on a regular basis, independently of the data access queries actually received by the server which may arrive in an unpredictable manner) and the node storing the addresses may have more up-to-date registration data 260 on a consistent basis in the long run, on average.

At block 420, the method may monitor the traffic in the peer-to-peer network 200 and query the nodes during periods of lower network traffic. For example, the node may observe the network to determine an average of network activity. During periods when network traffic is below the average, the node may query for registration information. In this manner, the traffic on the peer-to-peer network 200 may be more smooth and predictable as address queries may not be sent during times of high network traffic.

At block 430, the node may answer queries from additional nodes for peer name registration data 260. Instead of having to individually collect registration data 260, the other nodes on the peer-to-peer network 200 may know to query the node, which may be a server. The registration data 260 may be mirrored and stored in a second memory.

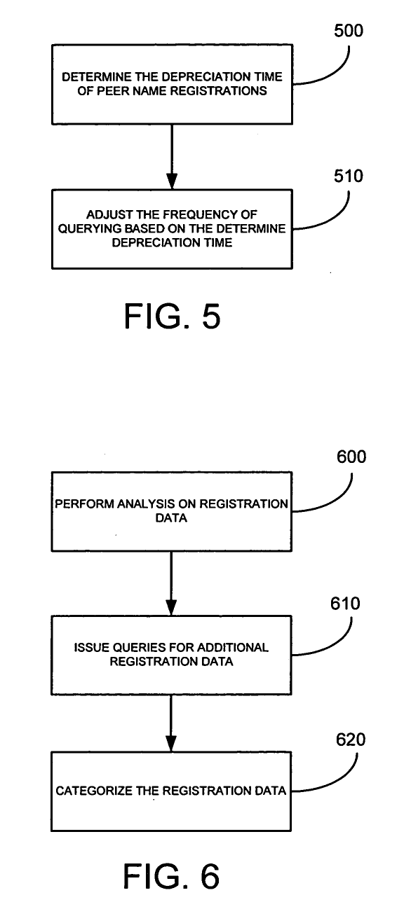

FIG. 5 may be another expansion of the method described in FIG. 4. At block 500, the method may determine the deprecation time of peer name registrations. Nodes may join and drop off of a peer-to-peer network 200. In addition, users may change their peer node registration information by changing names, changing computers, changing programs, etc. These changes may or may not be announced. In addition, these changes may be only be announced to part of the peer-to-peer network 200 with the assumption being that the rest of the peer-to-peer network 200 will find out over time. As a result, some registration information may become outdated or deprecated. The method may keep track of the time, on average, that it takes for registration data 260 to become deprecated or outdated. At block 510, the method may use this deprecation knowledge to adjust the frequency of querying based on the determined deprecation time. For example, if on average, node information become outdated every thirty minutes, the method may ensure that all nodes with registration information in the memory are queried for updated registration data 260 at least once every thirty minutes. If the deprecation time is lower, the time between queries may be lowered and if the deprecation time is higher, the time between queries may be increased.

FIG. 6 may illustrate another aspect of the invention. At block 600, the node that receives the registration data 260 described in FIG. 3 may also perform an analysis on registration data 260. This analysis might determine, based on client needs, how best to organize registration data to ensure that client queries receive the best possible response. For example, if the client applications are concerned with high speed file sharing, nodes may be categorized by their connection speed. At block 610, based on the analysis, the method may issue queries for additional registration data 260. For example, the method might query a node for its bandwidth information or its host uptime. In addition, at block 620, the method may categorize the registration data 260 based on the additional information retrieved.

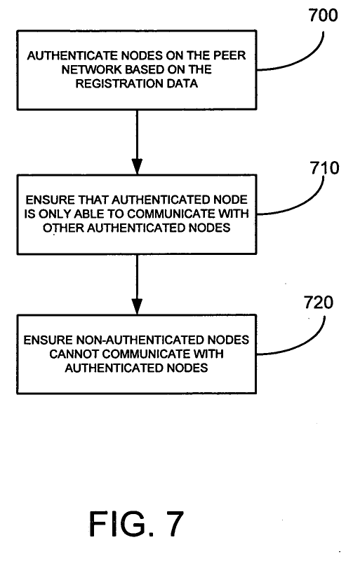

FIG. 7 may illustrate yet another aspect of the invention. At block 700 the method may authenticate nodes on the peer network based on the registration data 260. For example, in a peer-to-peer network, a malicious node may not pass on information to other nodes. Accordingly, information that is meant for additional nodes may not reach the intended nodes on the network. By authenticating nodes, it will be more difficult for malicious nodes to become part of the peer-to-peer network. Authentication may take on virtually any form, such as passing a test, a plurality of tests or a challenge. In addition, a first node may perform a first test and a second node may perform a second test. At block 710, the method may ensure that an authenticated node is only able to communicate with other authenticated nodes and at block 720, the method may ensure non-authenticated nodes cannot communicate with authenticated nodes.

As a result of adding a server 250 to a peer-to-peer network, the network may be more scalable as nodes do not have to take such great care in tracking network overhead such as ensuring that network addresses are valid. The server 250 can take care of this overhead. In addition, it may be easier to find peers on the peer network 200 performing the same activity. For example, the server 250 may categorize the peers by activity and Greg Brady could easily find other musicians that are attempting to start a rock and roll band, if such a category existed. The time required to find matching nodes may be greatly reduced. Finally, projects that require enormous computing power such as mapping the human genome may be able to manage the vast number of nodes that would be required to perform such operations.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

1. A computer implemented method of peer name discovery and resolution in a peer-to-peer network comprising
accepting peer name registrations data from a node;
if the peer name data is not in a first format, translating the peer name data into the first format;
storing the registration data in a memory; and
allowing additional nodes to access the registration data stored in the memory or additional registration data.

2. The method according to claim 1, further comprising querying nodes in the peer-to-peer network for registration data.

3. The method according to claim 2, wherein the querying is performed in a periodic basis.

4. The method according to claim 2, further comprising monitoring the traffic in the peer-to-peer network querying the nodes during periods of lower network traffic.

5. The method according to claim 2, further comprising answering queries from additional nodes for peer name registration data.

6. The method according to claim 1, wherein the peer name data is stored in a server on the peer-to-peer network.

7. The method according to claim 1, further comprising determining the depreciation time of peer name registrations.

8. The method according to claim 7, further comprising adjusting the frequency of querying based on the determined deprecation time.

9. The method according to claim 1, further comprising performing an analysis on registration data.

10. The method according to claim 9, further comprising issuing queries for additional registration data based on the analysis of the registration data.

11. The method according to claim 9, further comprising categorizing the registration data.

12. The method according to claim 1, further comprising authenticating nodes on the peer network based on the registration data.

13. The method according to claim 12, wherein an authenticated node is only able to communicate with other authenticated nodes.

14. The method according to claim 12, wherein non-authenticated nodes cannot communicate with authenticated nodes.

15. The method according to claim 12, wherein authentication is based on passing a test.

16. The method according to claim 1, wherein registration data is mirrored and stored in a second memory.

17. A tangible computer readable medium with computer executable instructions for peer name discovery in a peer-to-peer network comprising computer executable instruction for:
accepting peer name registrations data from a node;
authenticating the node on the peer network based on the registration data;
if the peer name data is not in a first format, translating the peer name data into the first format;
storing the registration data in a memory;
allowing an authenticated node to communicate with other authenticated nodes;
forbidding a non-authenticated nodes to communicate with authenticated nodes; and
allowing additional authenticated nodes to access the registration data stored in the memory.

18. The computer readable medium of claim 17, wherein the peer name data is stored in a server on the peer-to-peer network.

19. A server comprising a processor, a memory, an input device and an output device, the server being connected to a peer-to-peer network and the server being capable of executing computer instructions comprising:
accepting peer name registrations data from a node;
authenticating the node on the peer network based on the registration data;
if the peer name data is not in a first format, translating the peer name data into the first format;
storing the registration data in a memory;
allowing an authenticated node to communicate with other authenticated nodes;
forbidding a non-authenticated nodes to communicate with authenticated nodes; and
allowing additional authenticated nodes to access the registration data stored in the memory.

20. The server of claim 19, further comprising computer instructions to categorize the registration data.
